(19) United States
(12) Patent Application Publication
(10) Pub. No.: US 2024/0089056 A1
(43) Pub. Date: Mar. 14, 2024

(54) Method And User Equipment For Sidelink-Positioning Reference Signal Transmission In Mobile Communications

(71) Applicant: MediaTek Inc., Hsinchu City (TW)

(72) Inventor: Chiao-Yao Chuang, Hsinchu City (TW)

(21) Appl. No.: 18/239,594

(22) Filed: Aug. 29, 2023

Related U.S. Application Data
(60) Provisional application No. 63/374,610, filed on Sep. 6, 2022.

(51) Int. Cl. H04L 5/00; H04L 47/34; H04W 72/0446

(52) U.S. Cl. CPC H04L 5/0051; H04L 47/34; H04W 72/0446

(57) ABSTRACT

Various solutions for transmission of sidelink-positioning reference signal (SL-PRS) with respect to user equipment in mobile communications are described. Transmission user equipment (Tx UE) may determine an SL-PRS configuration. The SL-PRS configuration includes resource reservation information and a sequence identifier. Tx UE may transmit the SL-PRS configuration to at least one reception user equipment (Rx UE). The sequence identifier is transmitted through a data channel. The resource reservation information is transmitted through the data channel or a control channel.

### CROSS REFERENCE TO RELATED PATENT APPLICATION(S)

The present disclosure is part of a non-provisional application claiming the priority benefit of U.S. Patent Application No. 63/374,610, filed 6 Sep. 2022, the content of which herein being incorporated by reference in its entirety.

### TECHNICAL FIELD

The present disclosure is generally related to mobile communications and, more particularly, to transmission of sidelink-positioning reference signal (SL-PRS) with respect to user equipment (UE) in mobile communications.

### BACKGROUND

Unless otherwise indicated herein, approaches described in this section are not prior art to the claims listed below and are not admitted as prior art by inclusion in this section.

Sidelink Positioning Reference Signal (SL-PRS) is a reference signal used in the sidelink transmission between user equipment (UEs) in 5G New Radio (NR), for reception UE(s) (Rx UE(s)) to determine relative position information with respect to transmission UE (Tx UE).

Regarding SL-PRS transmission, some operations and parameters are required. In particular, a seed initialization is performed to generate a pseudo random sequence. More specifically, according to the following formulas, parameters of slot index, symbol index and an ID are required to obtain the seed initialization value so that the pseudo random sequence can be generated. The sequence r(m) is defined by:

$$\\ r ( m ) = \frac{1}{\sqrt{2}} ( 1 - 2 c ( 2 m ) ) + j \frac{1}{\sqrt{2}} ( 1 - 2 c ( 2 m + 1 )$$

where the pseudo-random sequence c(i) is defined in 3GPP [TS38.211, clause 5.2.1]. The pseudo-random sequence generator shall be initialized with:

$$\\ {c}_{init} = ( {2}^{22} ⌊ \frac{{n}_{ID , seq}^{SL - PRS}}{1024} ⌋ ) + {2}^{10} ( {N}_{symb}^{slot} {n}_{s , f}^{μ} + l + 1 ) ( 2 ( {n}_{ID , seq}^{SL - PRS} mod 1024 ) + 1 ) + ( {n}_{ID , seq}^{SL - PRS} mod 1024 ) ) mod {2}^{31}$$

where:
n_{s,f}^{μ} is the slot number within the radio frame,
l is the OFDM symbol within the slot to which the sequence is mapped,
n_{ID,seq}^{SL-PRS}∈{0, 1, . . . , 4095} is the sidelink PRS sequence ID, which, if not provided by higher layer, is obtained from the decimal representation of the CRC for the sidelink control information mapped to the PSCCH associated with the SL-PRS.

Further parameter of time and frequency resource location including a number of transmissions, periodicity, occupied set of symbols within a slot, occupied subcarriers in frequency (or resource elements) are needed for SL-PRS transmission as well.

However, in the current sidelink framework, since it does not always rely on network node (e.g., a base station) to schedule the transmissions of reference signals, the interferences to SL-PRS transmissions could be significant. Therefore, there is a need to provide proper schemes to reduce interference during SL-PRS transmissions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to transmission of SL-PRS with respect to user equipment in mobile communications.

In one aspect, a method may involve a Tx UE determining an SL-PRS configuration. The SL-PRS configuration includes resource reservation information and a sequence identifier. The method may also involve the Tx UE transmitting the SL-PRS configuration to at least one Rx UE. The sequence identifier is transmitted in a higher layer message by a data channel. The resource reservation information is transmitted by the data channel or a control channel.

In one aspect, a method may involve a Rx UE receiving an SL-PRS configuration from a Tx UE. The SL-PRS configuration includes resource reservation information and a sequence identifier. The sequence identifier is received in a higher layer message by a data channel. The resource reservation information is received by the data channel or a control channel.

In one aspect, a Tx RU may comprise a transceiver which, during operation, wirelessly communicates with at least one Rx UE of a wireless network. The Tx UE may also comprise a processor communicatively coupled to the transceiver. The processor, during operation, may perform operations comprising determining an SL-PRS configuration. The SL-PRS configuration includes resource reservation information and a sequence identifier. The processor may also perform operations comprising transmitting, via the transceiver, the SL-PRS configuration to the at least one Rx UE. The ID is transmitted in a higher layer message by a data channel. The resource reservation information is transmitted by the data channel or a control channel.

In one aspect, a Rx RU may comprise a transceiver which, during operation, wirelessly communicates with a Rx UE of a wireless network. The Rx UE may also comprise a processor communicatively coupled to the transceiver. The processor, during operation, may perform operations comprising receiving, via the transceiver, an SL-PRS configuration from a Tx UE. The SL-PRS configuration includes resource reservation information and a sequence identifier. The sequence identifier is received in a higher layer message by a data channel. The resource reservation information is received through the data channel or a control channel.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmission of SL-PRS with respect to user equipment in mobile communications. According to the present disclosure, a number of possible solutions may be implemented separately or jointly. That is, although these possible solutions may be described below separately, two or more of these possible solutions may be implemented in one combination or another.

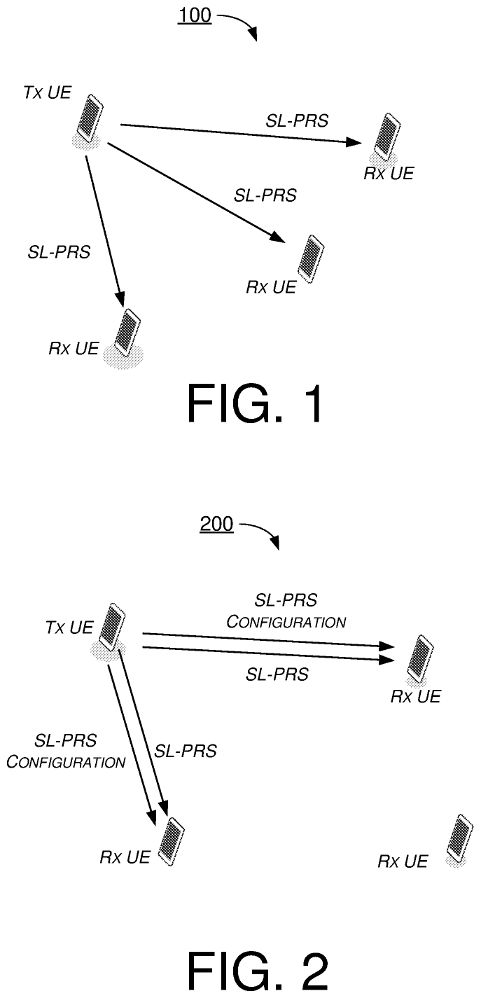

FIG. 1 illustrates an example scenario 100 under schemes in accordance with implementations of the present disclosure. Scenario 100 involves a Tx UE and a plurality of Rx UEs, which may be a part of a wireless communication network (e.g., an LTE network, a 5G/NR network, an IoT network or a 6G network) or may be without network access. Scenario 100 illustrates the current NR sidelink (SL) (i.e., NR-V2X) framework. The Tx UE may communicate with the Rx UEs. The Tx UE may transmit SL-PRS(s) to the Rx UEs. Each Rx UE may measure the corresponding SL-PRS and report the measurement results to a computation entity.

FIG. 2 illustrates an example scenario 200 under schemes in accordance with implementations of the present disclosure. Scenario 200 involves a Tx UE and a plurality of Rx UEs, which may be a part of a wireless communication network (e.g., an LTE network, a 5G/NR network, an IoT network or a 6G network). To reduce interference during SL-PRS transmission, the Tx UE may transmit an SL-PRS configuration, which includes resource reservation for the following SL-PRS transmission, to the Rx UEs so that the Rx UE may obtain information of coming SL-PRS transmission performed by the Tx UE and attempt to prevent possible collisions with respect to the SL-PRS transmission since the Rx UEs may further play the role as Tx UEs when there are transmission events.

The Tx UE performs an operation of sensing and resource selection (or reselection) within a time window, and then determines an SL-PRS configuration corresponding to the operation of sensing and resource selection. The SL-PRS configuration includes: (1) a sequence identifier, which is used for descrambling; and (2) resource reservation information. More specifically, the sequence identifier is for the Rx UE to descramble sequence. The resource reservation information is related to information of reserved time and frequency resources for transmitting SL-PRS. In some implementations, a value of the sequence identifier is selected between: (1) 0 to (2¹⁹−1); (2) 0 to (2¹⁸−1); (3) 0 to (2¹⁷−1); (4) 0 to (2¹⁶−1); (5) 0 to (2¹⁵−1); (6) 0 to (2¹⁴−1); or (7) 0 to (2¹³−1).

In some implementations, the SL-PRS configuration is transmitted in a higher layer message (i.e., higher layer data) by a data channel (e.g., physical sidelink shared channel (PSSCH)). In other words, the sequence identifier and the resource reservation information are transmitted through the data channel as higher layer message.

In some implementations, transmission(s) through the data channel is (are) transmitted by broadcasting or multicasting. For example, when the SL-PRS configuration is transmitted by the data channel by broadcasting, every Rx UE within the communication area of the Tx UE may decode and receive the SL-PRS configuration. Therefore, the Rx UE receiving the SL-PRS configuration from the Tx UE can avoid interference according to the resource reservation information of the SL-PRS configuration.

For another example, when the SL-PRS configuration is transmitted through the data channel by multicasting (or groupcasting), every Rx UE within the same UE group of the Tx UE may decode and receive the SL-PRS configuration. Therefore, the Rx UE receiving the SL-PRS configuration from the Tx UE can avoid interference according to the resource reservation information of the SL-PRS configuration.

For another example, when some parts of the SL-PRS configuration is transmitted through the data channel by unicasting, the corresponding Rx UE within the communication area of the Tx UE may decode and receive the corresponding SL-PRS configuration.

In some implementations, transmission(s) through the data channel is (are) transmitted by broadcasting or multicasting. In these implementations, the SL-PRS configuration further includes UE identification(s) of designated Rx UE(s) which need to perform the SL-PRS measurement.

It should be noted that, when the SL-PRS configuration is transmitted by broadcasting or multicasting (i.e., groupcasting), all the Rx UEs within the broadcasting coverage or all the Rx UEs in the same group may receive the SL-PRS configuration. But only the designated Rx UE(s) need to perform the SL-PRS measurement.

In some implementations, the resource reservation information can be independently transmitted through a control channel (e.g., physical sidelink control channel (PSCCH) that is commonly accessible to the UEs.

In some implementations, the resource reservation includes: (1) time and frequency resource information; and (2) a time domain behavior information. In particular, the time and frequency resource information includes: (1) a unit of set of symbol within slot, a slot index or a set of consecutive slots for a transmission; (2) and the resource elements in frequency domain for a transmission. The time domain behavior information includes a periodic transmission indication or a semi-persistent transmission indication. The periodic transmission indication may include a periodicity. The semi-persistent transmission indication may include a number of transmission and a periodicity. For example, the time and frequency resource information can be the information of positioning reference signal (PRS) structure within a slot. The information of PRS structure includes set of symbols, comb size, bandwidth and resource element (RE) offset structure.

In some implementations, after the operation of sensing and resource selection, the Tx UE transmits an SL-PRS for the corresponding Rx UE(s) to measures the SL-PRS and determines relative position information (e.g., relative location, distance, etc.) with respect to the Tx UE. In some cases, the reserved resources configured in the SL-PRS configuration are utilized to transmit the SL-PRS. In some cases, some resources, which are determined by lower layer, may still have collision with the signal from other UEs so that the measurement performance become poor. Therefore, further sensing and resource re-selection may be needed.

In some implementations, the control channel of a slot indicates SL-PRS transmission information within the slot, and the SL-PRS transmission information includes a set of symbols for transmission.

### Illustrative Implementations

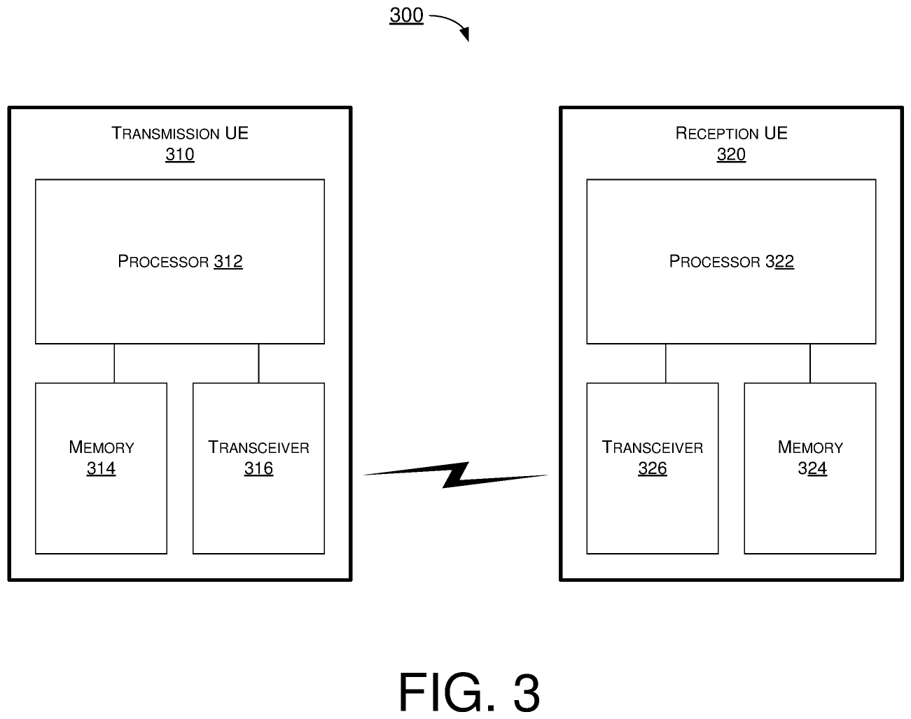

FIG. 3 illustrates an example communication system 300 having an example Tx UE 310 and an example Rx UE 320 in accordance with an implementation of the present disclosure. Each of Tx UE 310 and Rx UE 320 may perform various functions to implement schemes, techniques, processes and methods described herein pertaining to transmission of SL-PRS in mobile communications, including scenarios/schemes described above as well as process 400 described below.

Tx UE 310 may be a part of an electronic apparatus such as a portable or mobile apparatus, a wearable apparatus, a wireless communication apparatus or a computing apparatus. For instance, Tx UE 310 may be implemented in a smartphone, a smartwatch, a personal digital assistant, a digital camera, or a computing equipment such as a tablet computer, a laptop computer or a notebook computer. Tx UE 310 may also be a part of a machine type apparatus, which may be an IoT, NB-IoT, or IIoT apparatus such as an immobile or a stationary apparatus, a home apparatus, a wire communication apparatus or a computing apparatus. For instance, Tx UE 310 may be implemented in a smart thermostat, a smart fridge, a smart door lock, a wireless speaker or a home control center. Alternatively, Tx UE 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Tx UE 310 may include at least some of those components shown in FIG. 3 such as a processor 312, for example. Tx UE 310 may further include one or more other components not pertinent to the proposed scheme of the present disclosure (e.g., internal power supply, display device and/or user interface device), and, thus, such component(s) of Tx UE 310 are neither shown in FIG. 3 nor described below in the interest of simplicity and brevity.

Rx UE 320 may be a part of an electronic apparatus such as a portable or mobile apparatus, a wearable apparatus, a wireless communication apparatus or a computing apparatus. For instance, Rx UE 320 may be implemented in a smartphone, a smartwatch, a personal digital assistant, a digital camera, or a computing equipment such as a tablet computer, a laptop computer or a notebook computer. Rx UE 320 may also be a part of a machine type apparatus, which may be an IoT, NB-IoT, or IIoT apparatus such as an immobile or a stationary apparatus, a home apparatus, a wire communication apparatus or a computing apparatus. For instance, Rx UE 320 may be implemented in a smart thermostat, a smart fridge, a smart door lock, a wireless speaker or a home control center. Alternatively, Rx UE 320 may be implemented in the form of one or more IC chips such as, for example and without limitation, one or more single-core processors, one or more multi-core processors, one or more RISC processors, or one or more CISC) processors. Rx UE 320 may include at least some of those components shown in FIG. 3 such as a processor 322, for example. Rx UE 320 may further include one or more other components not pertinent to the proposed scheme of the present disclosure (e.g., internal power supply, display device and/or user interface device), and, thus, such component(s) of Rx UE 320 are neither shown in FIG. 3 nor described below in the interest of simplicity and brevity.

It should be noted that, in some implementations, Tx UE 310 may have the functions of Rx UE and be operated as a Rx UE while Rx UE 320 having the functions of Tx UE and being operated as a Tx UE.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a UE (e.g., as represented by Tx UE 310) and another UE (e.g., as represented by Rx UE 320) in accordance with various implementations of the present disclosure.

In some implementations, Tx UE 310 may also include a transceiver 316 coupled to processor 312 and capable of wirelessly transmitting and receiving data. In some implementations, Tx UE 310 may further include a memory 314 coupled to processor 312 and capable of being accessed by processor 312 and storing data therein. In some implementations, Rx UE 320 may also include a transceiver 326 coupled to processor 322 and capable of wirelessly transmitting and receiving data. In some implementations, Rx UE 320 may further include a memory 324 coupled to processor 322 and capable of being accessed by processor 322 and storing data therein. Accordingly, Tx UE 310 and Rx UE 320 may wirelessly communicate with each other via transceiver 316 and transceiver 326, respectively.

From Tx UE perspective, in some implementations, processor 312 may determine an SL-PRS configuration. The SL-PRS configuration includes resource reservation information and a sequence identifier. Processor 312 may transmit, via transceiver 316, the SL-PRS configuration to at least one Rx UE 320. The sequence identifier is transmitted in a higher layer message by a data channel. The resource reservation information is transmitted by the data channel or a control channel.

In some implementations, the SL-PRS configuration further includes at least one UE identification of the at least one Rx UE 320.

In some implementations, the transmission through the data channel is transmitted by broadcasting, groupcasting or unicasting.

In some implementations, the resource reservation information includes time and frequency resource information.

In some implementations, the time and frequency resource information includes a unit of set of symbol within slot, a slot index or a set of consecutive slots for a transmission.

In some implementations, the resource reservation information further includes a time domain behavior information which includes a periodic transmission indication or a semi-persistent transmission indication.

In some implementations, the periodic transmission indication includes a periodicity and the semi-persistent transmission indication includes a number of transmission and a periodicity.

In some implementations, processor 312 may perform an operation of sensing and resource selection within a time window.

In some implementations, processor 312 may transmit, via transceiver 316, an SL-PRS after the operation of sensing and resource selection.

In some implementations, the control channel of a slot indicates SL-PRS transmission information within the slot, and the SL-PRS transmission information includes a set of symbols for transmission.

In some implementations, the data channel includes PSSCH and the control channel includes PSCCH.

From Rx UE perspective, in some implementations, processor 322 may receive, via transceiver 326, an SL-PRS configuration from Tx UE 310. The SL-PRS configuration includes resource reservation information and a sequence identifier. The sequence identifier is received in a higher layer message by data channel. The resource reservation information is received by the data channel or a control channel.

In some implementations, the SL-PRS configuration further includes a UE identification of Rx UE 320.

In some implementations, a value of the sequence identifier is between 0 to (2¹⁹−1).

In some implementations, the resource reservation information includes time and frequency resource information.

In some implementations, the time and frequency resource information includes a unit of set of symbol within slot, a slot index or a set of consecutive slots for a transmission.

In some implementations, the resource reservation information further includes a time domain behavior information which includes a periodic transmission indication or a semi-persistent transmission indication.

In some implementations, processor 322 may receive, via transceiver 326, an SL-PRS after an operation of sensing and resource selection performed by Tx UE 312. The control channel of a slot indicates SL-PRS transmission information within the slot, and the SL-PRS transmission information includes a set of symbol for transmission.

In some implementations, the data channel includes PSSCH and the control channel includes PSCCH.

### Illustrative Processes

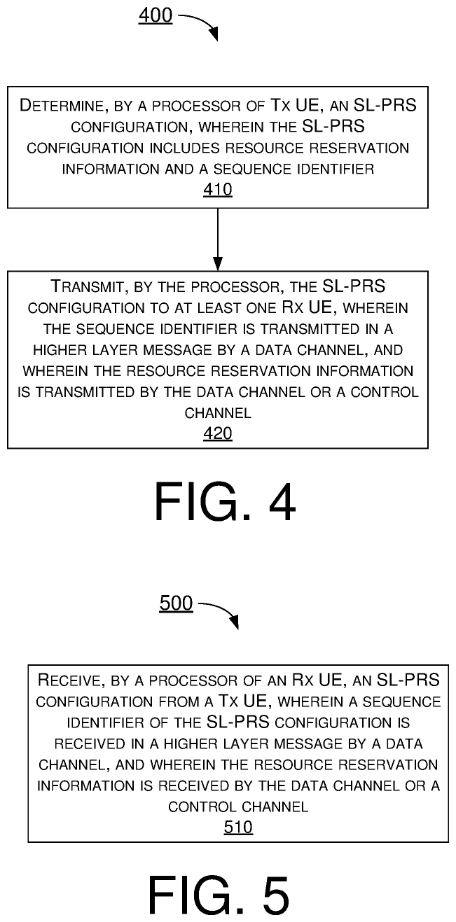

FIG. 4 illustrates an example process 400 in accordance with an implementation of the present disclosure. Process 400 may be an example implementation of above scenarios/schemes, whether partially or completely, with respect to transmission of SL-PRS with the present disclosure. Process 400 may represent an aspect of implementation of features of Tx UE 310. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by Tx UE 310 or any suitable UE or machine type devices. Solely for illustrative purposes and without limitation, process 400 is described below in the context of Tx UE 310. Process 400 may begin at block 410.

At 410, process 400 may involve processor 312 of Tx UE 310 determining an SL-PRS configuration. The SL-PRS configuration includes resource reservation information and a sequence identifier. Process 400 may proceed from 410 to 420. At 420, process 400 may involve processor 312 transmitting the SL-PRS configuration to at least one Rx UE. The ID is transmitted in a higher layer message by a data channel. The resource reservation information is transmitted by the data channel or a control channel.

In some implementations, process 400 may further involve processor 312 performing an operation of sensing and resource selection within a time window.

In some implementations, process 400 may further involve processor 312 transmitting an SL-PRS after the operation of sensing and resource selection.

FIG. 5 illustrates an example process 500 in accordance with an implementation of the present disclosure. Process 500 may be an example implementation of above scenarios/schemes, whether partially or completely, with respect to transmission of SL-PRS with the present disclosure. Process 500 may represent an aspect of implementation of features of Rx UE 320. Process 500 may include one or more operations, actions, or functions as illustrated by block 510. Although illustrated as discrete blocks, various blocks of process 500 may be divided into additional blocks, combined into fewer blocks, or eliminated, depending on the desired implementation. Process 500 may be implemented by Rx UE 320 or any suitable UE or machine type devices. Solely for illustrative purposes and without limitation, process 500 is described below in the context of Rx UE 320.

At 510, process 500 may involve processor 322 of Tx UE 320 receiving an SL-PRS configuration. The SL-PRS configuration includes resource reservation information and a sequence identifier. The sequence identifier is received in a higher layer message by a data channel. The resource reservation information is received by the data channel or a control channel.

In some implementations, process 500 may further involve processor 322 receiving an SL-PRS after an operation of sensing and resource selection performed by Tx UE 310. The control channel of a slot indicates SL-PRS transmission information within the slot, and the SL-PRS transmission information includes a set of symbols for transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a transmission user equipment (Tx UE), a sidelink-positioning reference signal (SL-PRS) configuration, wherein the SL-PRS configuration includes resource reservation information and a sequence identifier; and
transmitting, by the processor, the SL-PRS configuration to at least one reception user equipment (Rx UE),
wherein the sequence identifier is transmitted in a higher layer message by a data channel, and
wherein the resource reservation information is transmitted by the data channel or a control channel.

2. The method of claim 1, wherein the SL-PRS configuration further includes at least one UE identification of the at least one Rx UE.

3. The method of claim 1, wherein the transmission by the data channel is transmitted by broadcasting, groupcasting or unicasting.

4. The method of claim 1, wherein the resource reservation information includes time and frequency resource information.

5. The method of claim 4, wherein the time and frequency resource information includes a unit of set of symbol within slot, a slot index or a set of consecutive slots for a transmission.

6. The method of claim 4, wherein the resource reservation information further includes a time domain behavior information which includes a periodic transmission indication or a semi-persistent transmission indication.

7. The method of claim 6, wherein the periodic transmission indication includes a periodicity and the semi-persistent transmission indication includes a number of transmission and a periodicity.

8. The method of claim 1, further comprising:
performing, by the processor, an operation of sensing and resource selection within a time window.

9. The method of claim 7, further comprising:
transmitting, by the processor, an SL-PRS after the operation of sensing and resource selection.

10. The method of claim 8, wherein the control channel of a slot indicates SL-PRS transmission information within the slot, and wherein the SL-PRS transmission information includes a set of symbols for transmission.

11. The method of claim 1, wherein the data channel includes physical sidelink shared channel (PSSCH), and wherein the control channel includes physical sidelink control channel (PSCCH).

12. A method, comprising:
receiving, by a processor of a reception user equipment (Rx UE), a sidelink-positioning reference signal (SL-PRS) configuration from a transmission user equipment (Tx UE), wherein the SL-PRS configuration includes resource reservation information and a sequence identifier,
wherein the sequence identifier is received in a higher layer message by a data channel, and
wherein the resource reservation information is received by the data channel or a control channel.

13. The method of claim 12, wherein the SL-PRS configuration further includes a UE identification of the Rx UE.

14. The method of claim 12, wherein a value of the sequence identifier is between 0 to (2¹⁹−1).

15. The method of claim 12, wherein the resource reservation information includes time and frequency resource information.

16. The method of claim 15, wherein the time and frequency resource information includes a unit of set of symbol within slot, a slot index or a set of consecutive slots for a transmission.

17. The method of claim 15, wherein the resource reservation information further includes a time domain behavior information which includes a periodic transmission indication or a semi-persistent transmission indication.

18. The method of claim 17, further comprising:
receiving, by the processor, an SL-PRS after an operation of sensing and resource selection performed by the Tx UE, wherein the control channel of a slot indicates SL-PRS transmission information within the slot, and wherein the SL-PRS transmission information includes a set of symbols for transmission.

19. The method of claim 12, wherein the data channel includes physical sidelink shared channel (PSSCH), and wherein the control channel includes physical sidelink control channel (PSCCH).

20. A transmission user equipment (Tx UE), comprising:
a transceiver which, during operation, wirelessly communicates with at least one reception user equipment (Rx UE); and
a processor communicatively coupled to the transceiver such that, during operation, the processor performs operations comprising:
determining a sidelink-positioning reference signal (SL-PRS) configuration, wherein the SL-PRS configuration includes resource reservation information and a sequence identifier; and
transmitting, via the transceiver, the SL-PRS configuration to the at least one Rx UE,
wherein the sequence identifier is transmitted through a data channel, and
wherein the resource reservation information is transmitted through the data channel or a control channel.

21. A reception user equipment (Rx UE), comprising:
a transceiver which, during operation, wirelessly communicates with a transmission user equipment (Tx UE); and
a processor communicatively coupled to the transceiver such that, during operation, the processor performs operations comprising:
receiving, via the transceiver, a sidelink-positioning reference signal (SL-PRS) configuration from the Tx UE, wherein the SL-PRS configuration includes resource reservation information and a sequence identifier,
wherein the sequence identifier is received through a data channel, and
wherein the resource reservation information is received through the data channel or a control channel.
